(19) United States
(12) Patent Application Publication
(10) Pub. No.: US 2010/0328106 A1
(43) Pub. Date: Dec. 30, 2010

(54) EMERGENCY DEVICES

(75) Inventor: Anthony David Marshall, East Yorkshire (GB)

Correspondence Address: KIRTON & MCCONKIE, 60 EAST SOUTH TEMPLE, SUITE 1800, SALT LAKE CITY, UT, 84111, US

(73) Assignee: MARINE RESCUE TECHNOLOGIES LIMITED, East Yorkshire (GB)

(21) Appl. No.: 12/810,566

(22) PCT Filed: Dec. 30, 2008
(86) PCT No.: PCT/GB08/04304

§ 371 Date: Aug. 25, 2010

(30) Foreign Application Priority Data
Dec. 31, 2007 (GB) 0725357.8
Sep. 12, 2008 (GB) 0816743.9

(51) Int. Cl. G08B 23/00; G01S 19/17; G01S 19/13; G08B 21/00

(52) U.S. Cl. 340/984; 342/357.55; 342/357.51; 340/540

(57) ABSTRACT

A warning system is provided, which is particularly useful as a person overboard warning system. The system comprises a trigger part, worn by a crew member, which emits a signal on immersion in water. This is received by a receiver part on the vessel and automatically causes a transmitter part, also on the vessel, to send a further warning signal to one or more other locations remote from the vessel. These remote locations may be other vessels or land based sites, for instance operated by the coastguard or other rescue agencies. The automatic nature of the onward transmission of the signal received by the vessel makes the system particularly suited to single handed sailors.

This invention is concerned with improvements in and relating to emergency devices, particularly devices concerned with indicating a man overboard incident.

Due to a variety of causes, persons on water borne vessels can fall overboard and hence become separated from the vessel. For the safety of the person, it is important that this occurrence be detected and corrected as soon as possible.

Present man overboard indicating systems are provided on a vessel and inform persons on that vessel should a man overboard incident occur. The vessel the person fell from then needs to take action to recover the position.

In various instances, such as single-handed yachting, such an approach does not allow the position to be recovered.

The present invention has amongst its aims to provide a more widely informing system and/or a system of use in single-handed situations.

According to a first aspect of the invention we provide a warning system, the system comprising: a trigger part; a receiver part; and a transmitter part; the system being provided at a first location, wherein the trigger part is physically separate from the receiver part and transmitter part, wherein the trigger part has a signal emitter, and preferably an immersion sensor, to provide a signal to the receiver part upon immersion in water, the receiver part receiving signals from the trigger part and providing a further signal to the transmitter part to automatically cause a further warning signal to be emitted by the system, the further warning signal being sent to one or more other locations.

The warning system may be a person overboard warning system. The trigger part and receiver part may provide a person overboard warning system. The warning system may include a vessel in distress warning system, for instance by the transmitter part. The first location may be a vessel, particularly a water borne vessel. Preferably the crew and/or all persons on the vessel are provided with trigger parts.

The trigger part may be worn by a person. The trigger part may be incorporated into or be attached to an item of clothing and/or a life jacket and/or a life raft. The system may include a plurality of trigger parts which are separate from one another. The trigger part may emit a radio signal, for instance a signal at 121.50 MHz.

The trigger part may include a light, for instance, an electroluminescent light. The trigger unit may be provided with a power source, for instance a battery. The trigger part may be provided with a manual trigger. The trigger part may include information on the trigger part's identity. The trigger part may include an instrument for determining the trigger part's position, for instance a satellite based system, such as GPS.

The trigger part signal may include the identity of the trigger part. The trigger part signal may include the position of the trigger part.

The receiver part may be provided on a vessel, particularly a water borne vessel. The receiver part may provide a visual alarm when it receives a signal from a trigger part. The receiver part may provide an audible alarm when it receives a signal from a trigger part. The receiver part may include a directionally sensitive trigger part signal detector. The receiver part may indicate the direction of a trigger part providing a signal, for instance through a visual display. The receiver part may indicate the position of the trigger part in combination with other information. The other information may be navigational information, for instance a chart. The other information may be provided by another unit, for instance a navigational aid.

The further signal from the receiver part to the transmitter part may include information on the trigger part's identity and/or the trigger part's position. The further signal is preferably automatically provided to the transmitter part.

The transmitter part may include or be connected to an antenna, for instance a VHF signal transmitting antenna. The further warning signal may be detectably at least 5 km from the first location, preferably at least 50 km, more preferably at least 500 km and ideally at least 1000 km therefrom.

The transmitter part may be manually triggered and the preferably sends a further warning signal in such an instance. The manually triggered further warning signal may be a vessel in distress signal. The transmitter part may provide for the selection of one or more from a set of different distresses to be included in the further warning signal. The further warning signal may include the vessel's position and/or identity. The further warning signal may include information on the trigger part's identity and/or the trigger part's position. The further warning signal may be sent continuously or periodically without further user intervention. The transmitter part may be manually triggered to send the further warning signal to indicate a person overboard.

The further warning signal may be a VHF signal.

The one or more other locations are preferably locations remote to the first location. The one or more other locations may be one or more locations operated by or for authorities that provide rescue assistance to vessels and/or persons and/or coordinate such activities. The authority may be the coastguard, the military or a civilian organisation, such as an organisation operating rescue boats. The one or more other locations may be one or more other vessels. The one or more other locations may be remote in being at least 1 km from the first location, more preferably at least 5 km therefrom.

An interface part may be used to connect the receiver part to the transmitter part, particularly where the receiver part and/or transmitter part are pre-existing.

The system may include a distress signal receiver part to allow situations on other vessels to be detected and/or monitored.

Various embodiments of the invention will now be described, by way of example only and with reference to the accompanying drawings in which:

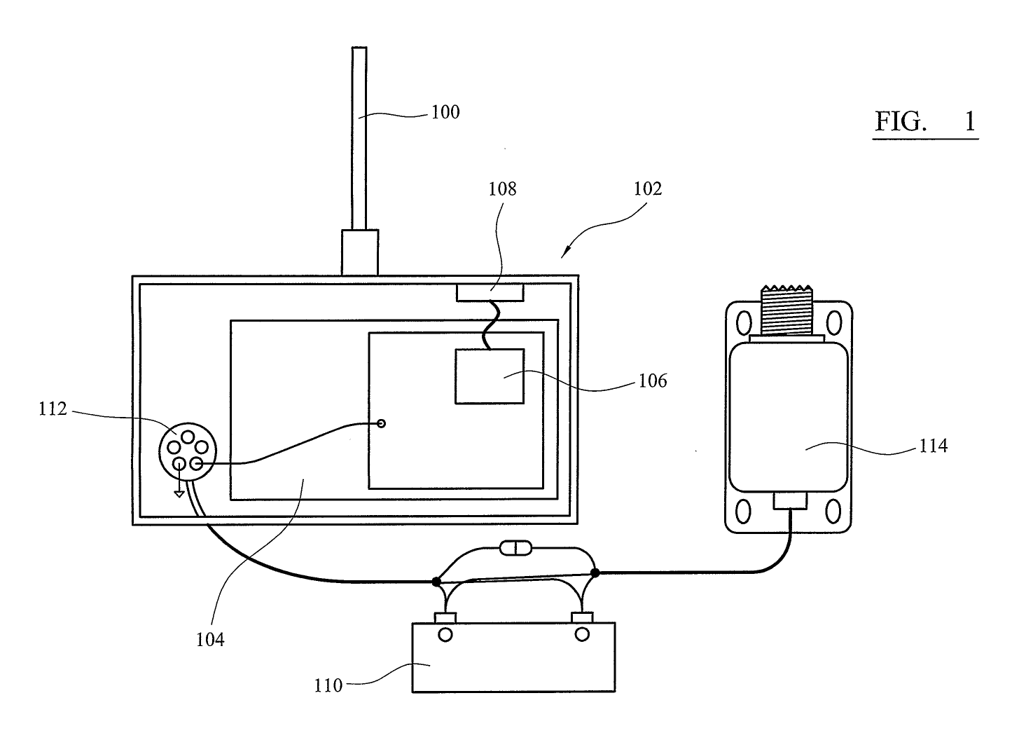

FIG. 1 is a schematically illustration of an interface unit in conjunction with other components of the system; and

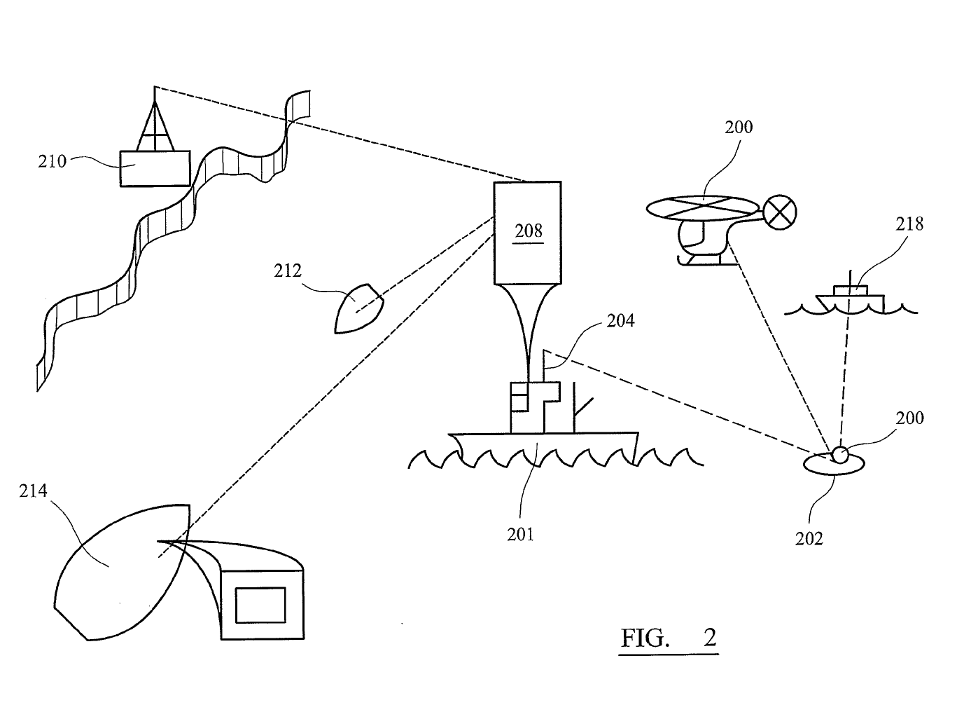

FIG. 2 is a schematic illustration of the system in use.

Water borne, particularly maritime, vessels are frequently provided with an automated distress signal transmission system. Digital Selective Calling, DSC, is one example of such a system. Generally DSC involves transmission and reception at a frequency of 156.525 MHz. Upon one time manual activation, the system continues to automatically transmit a distress signal. The type of signal may be selected by the person who triggers the system, for instance a “vessel on fire” distress signal. The signal is transmitted by a VHF transmitter on a channel which is constantly monitored for distress signals. Authorities and/or other vessels can then take appropriate action to assist the vessel.

Transmissions of this type are triggered by a person on the vessel interacting with the system.

Water borne, particularly maritime, vessels are provided in some cases with a man overboard alarm system. The life jacket worn by a person has a trigger part of the system. Upon immersion in water beyond a certain time period, the trigger part of the system sends a signal to the receiver part of the system provided on the vessel. This results in the receiver part providing a visual and/or audio signal of there being a man overboard to others on the vessel the person fell from. The receiver part is generally provided with directional sensitivity so as to be able to indicate to people on the vessel the position of the man overboard. This directional information assists in the recovery of the man overboard by enabling the vessel to be steered towards the man overboard.

The information provided by this type of system is only known to and used by the vessel from which the person has fallen.

Existing systems face shortcomings, for instance where there is only one person on board and they have fallen overboard. In such a case, there is no one on the vessel to respond to the man overboard alarm. There is also no one available to trigger the distress signal from the vessel.

The system of the present invention includes one or more man overboard trigger parts and attached antenna. The receiver part is provided on the vessel in a suitable location. The receiver part is connected to an interface part and through the interface part to a transmitter part. The transmitter part is connected to a VHF antenna. Also connected to the system is a distress signal receiver part to allow situations on other vessels to be monitored.

The trigger parts are often integrated into life jackets, but may be otherwise provided. The trigger part is mounted at a level on the life jacket which is partially immersed in normal use. The antenna extends up and around the neck of the user so as to provided a good transmission location. The trigger part transmits at 121.50 MHz.

The receiver part includes a visual alarm and an audible alarm so as to draw the attention of persons on the vessel to the existence of the man overboard incident. The receiver part also includes a display to indicate to users the direction of the trigger part relative to the vessel.

The interface part passes the occurrence of the man overboard incident to the transmitter part and causes a distress signal to be emitted through the VHF antenna.

The transmitter part is capable of being manually triggered by a person on the vessel.

The distress signal may simply indicate that the vessel is in distress, but more preferably indicates one of a variety of distress situations as applying. These may be that the vessel has a fire on board, has suffered a loss of power or is sinking. The distress signal in these cases has a component to indicate that it is a distress signal and a component to indicate the type of distress being suffered. Additionally, the signal may include the vessel's position and/or identity so as to assist in dealing with the distress incident. The distress signal may be transmitted on channel 70.

Where the interface part passes on the man overboard occurrence to the transmitter part, the emission of the distress signal is automatically sent. It would include an indication that the distress is a man overboard incident as a component of the signal.

Because the man overboard incident is automatically transmitted and is transmitted beyond the vessel from which the person has fallen, it is of benefit in situations where the vessel itself is not able to deal with the incident. This may be because the only person on board has fallen from the vessel. Even where people remain on the vessel, the automated transmission is of benefit in providing as early a warning as possible.

The interface part allows a pre-existing man overboard monitoring system to be connected to a pre-existing automated distress system with minimum expense or modification.

The interface part may be connected in parallel to an existing DSC unit provided on the vessel. A shared power supply and VHF transmitting antenna may be used. It is also possible for the interface part to be connected in series with an existing DSC unit provided on the vessel, with the DSC unit being triggered by the interface part to transmit information it possesses, such as the vessel's identification and vessel's position, alongside information from the interface part, such as the trigger part's identity and the tripper part's position. the combined information would be transmitted using the antenna the DSC is already connected too.

In another embodiment, the receiver part, interface part and transmitter part may be provided within a bespoke, integral unit.

In another embodiment, the system may be provided with the receiver part, interface part and transmitter part within a integral unit, with a parallel unit providing the manually triggered distress signals. These may be sent to the same or separate antenna.

In another embodiment, the distress signal may include a component indicating that the man overboard was the only person on board and/or that the vessel is no longer under control.

In another embodiment, the vessel's position may be included in the distress signal, with the information being provided by a Global Positioning System, GPS.

In another embodiment, the position of the trigger part may be transmitted to the vessel and then be included in the distress signal. The position may be updated over time.

In another embodiment, the identity of the trigger part may be included in the signal transmitted to the vessel and then be included in the distress signal.

In another embodiment, the system may incorporate into the distress signal information on or from multiple trigger parts.

In the full system, the trigger part provides information on the trigger part's position, the trigger part's identity and that the trigger part is overboard. This information is combined with information on the vessel's position, the vessel's identity and that the vessel has a man overboard. If the man overboard is the only person on board, the signal includes an indication of this or that the vessel is no longer under control. The trigger part's position and/or vessel's position may be continuously or periodically updated and transmitted.

Such a system is highly beneficial in providing an indication to remote locations that a man overboard situation has occurred within 5-10 seconds of that situation occurring.

An example of such a system is shown in FIG. 1. The system includes a man overboard beacon receiver 100 in the form of an antenna. The receiver 100 is connected to the interface unit 102. The interface unit 102 contains the control electronics 104, which includes the inbuilt GPS unit 106 which is connected to a GPS antenna 108 connected to the outside of the interface unit 102. The interface unit 102 is connected to an on board power supply 110 through a connector 112. The connector 112 is also used to connect the interface unit 102 to the VHF antenna 114 to transmit the signals to locations remote from the vessel. The control electronics 104 include pre-programmed information, preferably in Maritime Mobile Service Identity format, as to the vessels identity and the selected distress signal to be used. The distress signal may be pre-configured to or be selectable to be set to, the format compatible with the rescue system protocol to indicate a man overboard situation and that the vessel is no longer under control for the geographic location the system is being used in.

As shown in FIG. 2, a man overboard 200 from vessel 202 results in a signal from the trigger unit 204 worn being sent to the receiver antenna 206 on the vessel 202 the man overboard has fallen from. The system 208 there causes the DSC signal to be transmitted including information on position, identity etc to any monitoring parties. The monitoring parties may include the coastguard 210 on shore, a further small craft 212 nearby, a cargo vessel 214 in the vicinity etc. Any one of these may effect the rescue of the man overboard or assist in the process. The knowledge that the vessel 202 is not under control enables nearby vessels 212 and 214 to avoid the vessel 202.

In the illustrated example, the coastguard 210 effect the rescue by calling out a rescue helicopter 216. Once close to the man overboard trigger unit, the helicopter 216 is able to use the man overboard trigger unit signal to direct the helicopter 216 to the man overboard. A rescue vessel 218 can similarly locate the man overboard.

The trigger unit 204 communicating with the vessel 202 and the vessel 202 communicating with the remote location's via a separate transmission is beneficial over the trigger unit 204 trying to communicate with the remote locations directly because of the difficulties with achieving detection of transmissions from a partially submerged and relatively small antenna over any great distance.

The system on the vessel from which a person falls can include a display unit which gives an indication of a man overboard occurrence(s), the separate GPS position of the trigger unit(s). The GPS position(s) can be linked to onboard navigational aids to present the position(s) in the context of information from those aids, for instance as a position on a chart plotter.

1.-32. (canceled)

33. A warning system, the system comprising:
a trigger part;
a receiver part; and
a transmitter part;
the system being provided at a first location, wherein the trigger part is physically separate from the receiver part and the transmitter part, wherein the trigger part has a signal emitter to provide a signal to the receiver part upon immersion in water, the receiver part receiving signals from the trigger part and providing a further signal to the transmitter part to automatically cause a further warning signal to be emitted by the system, the further warning signal being sent to at least one other location.

34. A system according to claim 33 in which the further signal from the receiver part to the transmitter part includes information on at least one of the trigger part's identity and the trigger part's position.

35. A system according to claim 33 in which the further signal is automatically provided to the transmitter part.

36. A system according to claim 33 in which the receiver part is provided on a vessel.

37. A system according to claim 33 in which the further warning signal includes at least one of the vessel's position and the vessel's identity.

38. A system according to claim 33 in which the further warning signal includes information on at least one of the trigger part's identity and the trigger part's position.

39. A system according to claim 33 in which the further warning signal includes a vessel in distress signal.

40. A system according to claim 33 in which the further warning signal is detectably at least 50 km from the first location.

41. A system according to claim 33 in which the at least one other locations include at least one location operated by or for authorities that provides rescue assistance to at least one of vessels and persons, and coordinate such rescue activities.

42. A system according to claim 41 in which the at least one location operated by or for authorities includes at least one other vessel.

43. A system according to claim 33 in which the transmitter part is manually triggered and sends a further warning signal, a manually triggered further warning signal.

44. A system according to claim 43 in which the manually triggered further warning signal is a vessel in distress signal.

45. A system according to claim 44 in which the transmitter part provides for the selection of at least one distress signal from a set of different distresses included in the manually triggered further warning signal.

46. A system according to claim 46 in which the trigger part is coupled to at least one of an item of clothing, a life jacket, and a life raft.

47. A system according to claim 33 in which the system includes a plurality of trigger parts which are separate from one another.

48. A system according to claim 33 in which the trigger part includes at least one of a light, an electroluminescent light, a power source, a battery, a manual trigger, and an immersion sensor.

49. A system according to claim 33 in which the trigger part includes an instrument for determining the trigger part's position.

50. A system according to claim 49 in which the instrument is part of a satellite based GPS system.

51. A system according to claim 33 in which the receiver part includes at least one of a visual alarm activated when it receives a signal from a trigger part, an audible alarm activated when it receives a signal from a trigger part, and a directionally sensitive trigger part signal detector.

52. A system according to claim 33 in which the receiver part indicates the direction of a trigger part providing the signal.

53. A method of providing further warning signal, the method including:
providing a warning system, the system comprising:
a trigger part;
a receiver part; and
a transmitter part;
the system being provided at a first location, wherein the trigger part is physically separate from the receiver part and transmitter part;
providing a signal from a signal emitter in the trigger part to the receiver part upon immersion in water of the trigger part;
providing a further signal to the transmitter part to automatically cause a further warning signal to be emitted by the system, the further warning signal being sent to at least one other location when the receiver part receives the signal from the trigger part.

54. A method according to claim 53 in which the method provides a person overboard warning system.

55. A method according to claim 53 in which the first location is a water borne vessel.

56. A method according to claims 55 in which at least one person on the water borne vessel is provided with trigger parts.

57. A method according to claims 53 in which the further signal from the receiver part to the transmitter part includes at least one of information on the trigger part's identity and the trigger part's position.

58. A method according to claims 53 in which the further signal is automatically provided to the transmitter part.

59. A method according to claims 53 in which the further warning signal includes at least one of the vessel's position and the vessel's identity.

60. A method according to claims 53 in which the further warning signal includes information on at least one of the trigger part's identity and the trigger part's position.

61. A method according to claims 53 in which the further warning signal includes a vessel in distress signal.

62. A method according to claims 53 in which the further warning signal is detectable at least 50 km from the first location.

63. A method according to claims 53 in which the at least one other locations includes a location operated by or for authorities that provide rescue assistance to at least one of vessels and persons, and coordinate such rescue activities.

64. A method according to claims 53 in which the at least one other locations include at least one other vessels.
